(19) United States
(12) Patent Application Publication
(10) Pub. No.: US 2026/0227213 A1
(43) Pub. Date: Aug. 6, 2026

(54) Commodity Monitoring Systems, Cable Assemblies, Cable Sensor Nodes, And Related Methods And Systems

(71) Applicant: GSI Electronique Inc, Saint-Hubert (CA)

(72) Inventors: Maxime AUGUSTIN, St-Hubert (CA); Guillaume LECLERC, St-Hubert (CA)

(21) Appl. No.: 19/149,055

(22) PCT Filed: Dec. 11, 2023
(86) PCT No.: PCT/IB2023/062455

§ 371 Date: Jul. 17, 2025

(30) Foreign Application Priority Data
Jan. 22, 2023 (GB) 2300935.0

(51) Int. Cl. G01D 11/24; A01F 25/16

(52) U.S. Cl. CPC G01D 11/245; A01F 25/16

(57) ABSTRACT

A commodity monitoring system includes a cable assembly in communication with at least one computing device. The cable assembly includes a plurality of cables, each cable including a pair of conductors and a plurality of sensor nodes secured to the plurality of cables. Each sensor node of the plurality of sensor nodes includes a circuit board disposed within a respective cable of the plurality of cables and interposed between the pair of conductors of the respective cable, wherein each lateral side surface of the circuit board faces a respective conductor of the pair of conductors of the respective cable, and wherein each lateral side surface of the circuit board is oriented at least substantially perpendicular to a plane extending between longitudinal axes of the pair of conductors of the respective cable and within which the center longitudinal axes of the pair of conductors lie.

### FIELD

Embodiments generally relate to grain monitoring. In particular, embodiments relate to sensor nodes secured to cables used in the monitoring of stored commodities (e.g., grain).

### BACKGROUND

In the monitoring of commodities within storage bins, it is important to monitor certain parameters to keep the stored commodities cool and dry. Based on the monitored parameters, determinations that the stored commodities need aeration and/or by churning may be made. In cable-based monitoring, parameters are typically monitored via sensor nodes suspended by cables. When cables are installed in the storage bins, movement of the cables based on, for instance, the ingress, egress, or churning of grain, may lead to breaks or disruptions in connections to the sensor nodes (e.g., circuitry of the sensor nodes), resulting in a loss of data from the affected sensor nodes.

### BRIEF SUMMARY

Some embodiments include a sensor node including a cable having a pair of conductors surrounded by a cable jacket and a circuit board disposed within the cable and interposed between the pair of conductors of the cable.

The circuit board may include a plurality of spring contacts extending away from lateral sides of the circuit board and configured to contact the pair of conductors of the cable.

Each lateral side surface of the circuit board may face a respective conductor of the pair of conductors, and each lateral side surface of the circuit board may oriented at least substantially perpendicular to a plane extending between center longitudinal axes of the pair of conductors of the cable and within which the center longitudinal axes of the pair of conductors lie.

The circuit board may include one or more sensors.

The sensor node may also include at least one seal member disposed on the cable and covering the circuit board.

The circuit board and a portion of each of the pair of conductors may be enclosed in a housing structure.

The sensor node may also include where at least two spring contacts of the plurality of spring contacts comprise a conductive material.

One of the at least two spring contacts may extend from a first lateral side of the circuit board, and another of the at least two spring contacts may extends from a second, opposite lateral side of the circuit board.

The conductive material may include a metallic material.

The conductive material may include a non-metallic material.

At least two spring contacts of the plurality of spring contacts may include a non-conductive material.

The one or more sensors may include at least one of a temperature sensor, a moisture sensor, a humidity sensor, a relative humidity sensor, or a carbon dioxide sensor.

The at least one seal member may include a first seal member disposed on a first side of the cable and a second seal member disposed on a second, opposite side of the cable.

The sensor node may also include at least one filter or membrane disposed within an aperture extending through the at least one seal member and providing a hydrophobic vent.

The housing structure may include a first piece and a second piece.

Some embodiments include a method of forming a sensor node on a cable. The method may include forming an opening in a cable jacket of the cable, and disposing a circuit board at least partially within the cable and in-between two conductors of the cable with a first lateral side of the circuit board facing a first conductor of the two conductors and a second lateral side of the circuit board facing a second conductor of the two conductors.

The method may also include disposing a first seal member over the opening in the cable jacket and over the circuit board disposed within the cable.

Forming the opening in the cable jacket of the cable may include forming the opening completely through the cable and through both sides of the cable jacket of the cable.

Disposing the circuit board at least partially within the cable and in-between the two conductors of the cable may include causing spring contacts of the circuit board to contact at least one of the two conductors of the cable.

Some embodiments include a commodity monitoring system having at least one computing device, a container for storing a commodity, and a cable assembly installed within the container and in communication with the at least one computing device. The cable assembly may include a plurality of cables, each cable including a pair of conductors. The commodity monitoring system may also include a plurality of sensor nodes secured to the plurality of cables, each cable of the plurality of cables having at least one sensor node of the plurality of sensor nodes secured thereto. Each sensor node of the plurality of sensor nodes may include a circuit board disposed within a respective cable of the plurality of cables and interposed between the pair of conductors of the respective cable, where each lateral side surface of the circuit board faces a respective conductor of the pair of conductors of the respective cable, and where each lateral side surface of the circuit board is oriented at least substantially perpendicular to a plane extending between center longitudinal axes of the pair of conductors of the respective cable and within which the center longitudinal axes of the pair of conductors lie.

Other technical features may be readily apparent to one skilled in the art from the following figures, descriptions, and claims.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 shows a schematic representation of a commodity monitoring system having a cable assembly and sensor nodes according to one or more embodiments of the present disclosure;

FIG. 2A shows a side view of a sensor node secured to a cable according to one or more embodiments of the present disclosure;

FIG. 2B shows an exploded, perspective view of the sensor node of FIG. 2A;

FIG. 3A shows a perspective view of a circuit board of a sensor node from a first lateral side;

FIG. 3B shows a perspective view of the circuit board of FIG. 3A from a second, opposite lateral side;

FIG. 4 shows a schematic representation of a circuit board of a sensor node according to one or more embodiments of the present disclosure;

FIG. 5 shows a cross-sectional view of a sensor node according to one or more embodiments of the present disclosure; and

FIGS. 6A-6C show schematic representations of cables and sensor nodes according to some embodiments of the present disclosure.

### DETAILED DESCRIPTION

Illustrations presented herein are not meant to be actual views of any particular storage container, cable assembly, cable, sensor node, component, or system, but are merely idealized representations that are employed to describe embodiments of the disclosure. Additionally, elements common between figures may retain the same numerical designation for convenience and clarity.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “third,” etc. is used for clarity and convenience in understanding the disclosure and accompanying drawings, and does not connote or depend on any specific preference or order, except where the context clearly indicates otherwise.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “and/or” includes any and all combinations of one or more of the associated listed items.

Embodiments of the disclosure include a cable assembly for monitoring a commodity (e.g., a grain) within a container (e.g., a storage bin) and having cables and sensor nodes secured to the cables. The sensor nodes may include circuit boards (e.g., printed circuit boards) that are disposed (e.g., interposed) between two electrical conductors of the cables. The circuit boards may include a plurality of spring contacts (e.g., biased contacts) extending from lateral sides of the circuit boards and sized and shaped to contact the conductors of the cables and establish electrical connections between the circuit boards and the conductors of the cables.

Some embodiments of the disclosure include sensor nodes that are arranged in spaced-apart positions along cables that are affixed to top structures of a storage container (e.g., grain storage bin). The sensor nodes may include monitoring circuitry, and a printed circuit board of each sensor node may be secured between conductors of a respective cable to provide a relatively robust connection between the monitoring circuitry and the conductors of the cable. For instance, the circuit board of each sensor node may include a plurality of spring contacts attached to each lateral side of the circuit board (e.g., one or more spring contacts on one lateral side, and one or more spring contacts on an opposite lateral side). The plurality of spring contacts secure the circuit board between the conductors of the cable, while providing conductive paths for power/data and ground. For instance, the plurality of spring contacts may provide resistance to movement of the circuit board relative to the conductors, even when the conductors move or deflect, which may provide robust and persistent connections between the circuit board and the conductors.

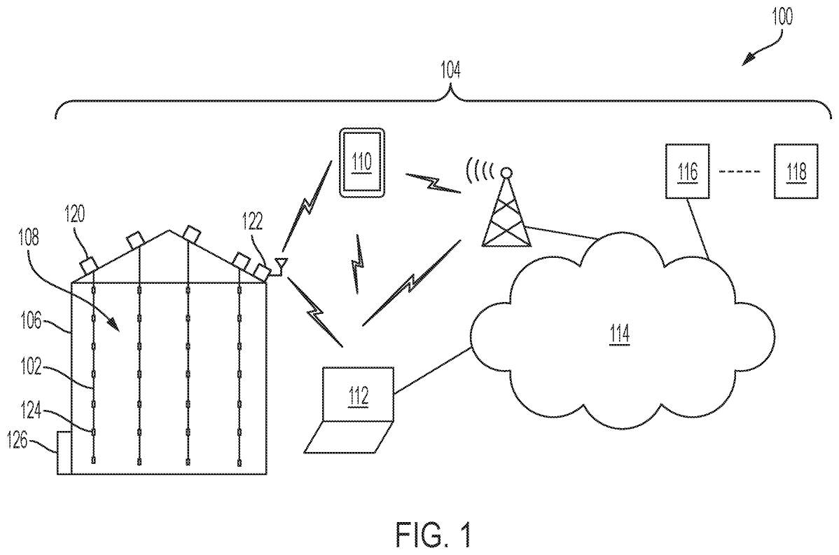

FIG. 1 shows a schematic diagram of an environment 100 in which a sensor node (e.g., a cable sensor node) may be implemented and operated according to one or more embodiments of the present disclosure. The environment 100 may include a cable assembly 108 having a plurality of cables 102 suspended within a container 106, at least one client device 110, 112, at least one server 116, 118, and a network 114. The at least one server 116, 118, the at least one client device 110, 112, and the cable assembly 108 may communicate via the network 114 and may form a commodity monitoring system 104. Although FIG. 1 illustrates a particular arrangement of the at least one client device 110, 112, the at least one server 116, 118, the cable assembly 108, and the network 114, various additional arrangements are possible. For example, the at least one server 116 can communicate directly with the at least one client device 110, 112, and/or the cable assembly 108, thereby bypassing the network 114.

The container 106 may include a grain storage bin. Furthermore, while a particular geometry is depicted in FIG. 1, it understood that the container 106 may include one or more containers of other geometries, for the same contents (e.g., grain) or other contents, with a different arrangement and/or quantity of inlet, outlet, and/or side ports.

The cable assembly 108 may include a plurality of cables 102 coupled to and suspended from one or more top structures of a container 106. In some embodiments, one or more of the plurality of cables 102 may be coupled to a floor of the container 106 via, for instance, a floor anchor. The plurality of cables 102 may each be operably coupled to a respective cable hub 120, and each cable hub 120 may be in communication (e.g., via wired and/or wireless communication) with a communications gateway 122, which in turn may be in communication with the network 114, and as a result, the at least one client device 110, 112 and/or at least one server 116, 118.

The cable assembly 108 may be utilized to monitor contents (e.g., a commodity) within the container 106. For example, each cable 102 of the cable assembly 108 may include one or more sensor nodes 124 coupled (e.g., secured) to the cable 102. In some embodiments, a given cable 102 may include a plurality of sensor nodes 124, and the plurality of sensor nodes 124 may be spaced apart from each along a longitudinal length of the given cable 102. As a result, when a commodity (e.g., a grain) is stored within the container 106, the sensor nodes 124 of each cable 102 may be vertically distributed throughout the commodity.

The one or more sensor nodes 124 may include one or more of humidity sensors, relative humidity sensors, temperature sensors, moisture sensors, and/or carbon dioxide (CO₂) sensors. Spacing between sensor nodes 124 may be selected based on the type of sensors and/or type of commodity. Additionally, a quantity of cables 102 may be selected based at least partially on one or more of a region (e.g., climate) in which the container 106 is located, a type of commodity stored, a size of the container 106, air flow conditions within the container 106, and the types of sensors of the sensor nodes 124.

n some embodiments, a user can interface with one or more of the at least one client device 110, for example, to communicate with the server 116 and to utilize the commodity monitoring system 104 to monitor contents of the container 106. The user may include one or more operators of the container 106 and/or commodity monitoring system 104. Although FIG. 1 shows only two client devices 110, 112, the environment 100 can include any number of client devices 110, 112 in communication with the network 114, the at least one server 116, 118, and/or the cable assembly 108.

In some embodiments, the client device 110, 112 may include a client application installed thereon. In one or more embodiments, the client application can be associated with the commodity monitoring system 104. For example, the client application may allow the client device 110, 112 to directly or indirectly interface with other elements (e.g., the cable assembly 108, the at least one server 116, 118) of the commodity monitoring system 104. The client application also enables a user (e.g., an operator) to initiate measurements via the commodity monitoring system 104 and observe any results of the measurements (e.g., measured humidity, measure temperatures, measured moisture levels, etc.).

Both the at least one client device 110, 112 and the at least one server 116, 118 (and the commodity monitoring system 104) can represent various types of computing devices with which operators can interact. For example, the at least one client device 110, 112 and/or the at least one server 116, 118 may include a mobile device (e.g., a cell phone, a smartphone, a PDA, a tablet, a laptop, a watch, a wearable device, etc.). In some embodiments, however, the at least one client device 110, 112 and/or at least one server 116, 118 can be a non-mobile device (e.g., a desktop or server). In some embodiments, the at least one server 116, 118 may include a cloud computing platform and may be configured to perform processing required to implement one or more portions of the commodity monitoring system 104. In one or more embodiments, the at least one server 116, 118 may include a web server that provides a web site that can be used by operators monitoring the contents of the container 106 via a remote client device 110, 112.

The network 114 may include one or more networks, such as the Internet, and can use one or more communications platforms or technologies suitable for transmitting data and/or communication signals. As a non-limiting example, the network 114 may utilize one or more of near field communication (NFC), BLUETOOTH©, wireless/cellular networks, wide area networks (WAN), wired communications, or any other conventional network for transmitting data and/or communication signals between the cable assembly 108, the client device 110, 112, and the server 116, 118.

Referring still to FIG. 1, in some embodiments, one or more of the at least one client device 110, 112, the cable assembly 108, or the at least one server 116, 118 may include a display for displaying data regarding measurements obtained via the cable assembly 108. In some embodiments, the data may include one or more parameters of commodity within the container 106. The parameters may include one or more of temperature, humidity, relative humidity, moisture, or carbon dioxide. In some embodiments, the commodity monitoring system 104 may utilize the parameters to determine when to actuate commodity management devices 126 of the container 106 to affect conditions of the commodity. The commodity management devices 126 may include one or more of heaters, fans, blowers, churners, vents, etc.

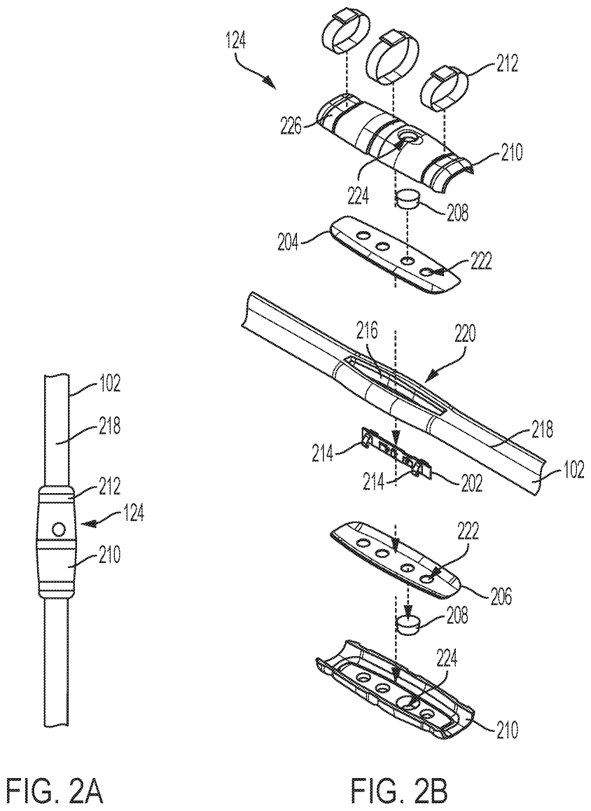

FIG. 2A shows a side view of a sensor node 124 coupled to a cable 102 according to one or more embodiments of the disclosure. FIG. 2B is a perspective, exploded view of the sensor node 124 and the cable 102 of FIG. 2A. Referring to FIG. 2A and FIG. 2B together, the sensor node 124 may include a circuit board 202, a first seal member 204, a second seal member 206, at least one filter and/or membrane 208, an outer casing 210, and one or more fasteners 212. The cable 102 may include one or more conductors 216 (e.g., wires, metal cables, etc.) within a cable jacket 218.

As depicted in FIG. 2B, the cable 102 may include a slot or opening 220 formed through the cable jacket 218 of the cable 102 and exposing a pair of conductors 216 of the cable 102. In some embodiments, the slot or opening 220 may extend through both sides of the cable 102 (e.g., the cable jacket 218 on both sides of the cable 102). In other embodiments, the slot or opening 220 may extend through only one side of the cable 102 (e.g., through only one side of the cable jacket 218 in a direction orthogonal to a longitudinal axis of the cable 102). In one or more embodiments, the pair of conductors 216 may include any conventional conductors, such as for example, copper, aluminum, nickel, stainless steel, galvanized steel, a metal alloy, or a metal-containing material. In some embodiments, each conductor 216 may have a diameter within a range of about 3.0 millimeters (mm) to about 15 millimeters (mm). For example, each conductor 216 may have a diameter of about 4.75 millimeters (mm). In some embodiments, a distance between center longitudinal axes of the conductors 216 may be within a range of about 3.0 millimeters (mm) and about 8.0 millimeters (mm). As a non-limiting example, the distance between center longitudinal axes of the conductors 216 may be about 6.35 millimeters (mm). In some embodiments, the cable jacket 218 may include an insulative material, such as, for example, a high-density polyethylene (HDPE) material.

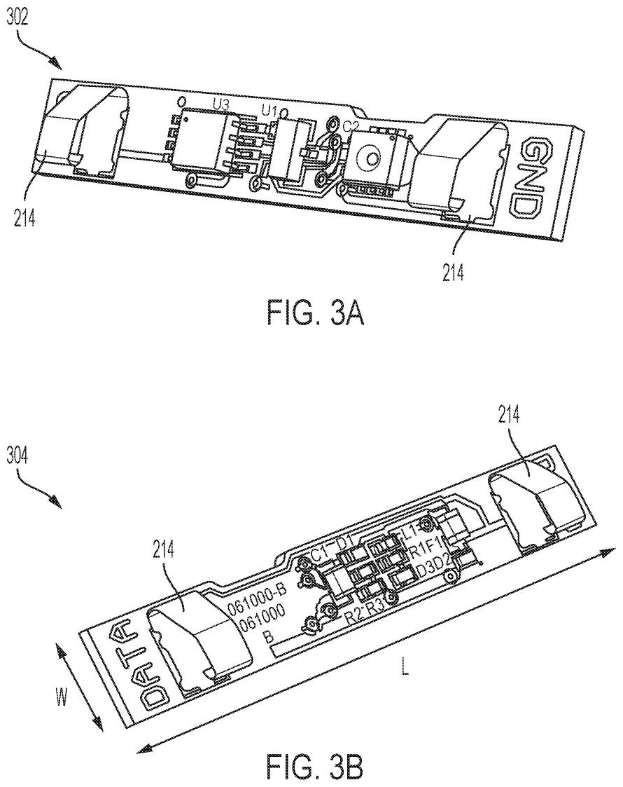

FIG. 3A shows a perspective view of a first lateral side 302 of the circuit board 202 of FIG. 2A and FIG. 2B. FIG. 3B shows a perspective view of a second, opposite lateral side 304 of the circuit board 202. Referring to FIGS. 2A-3B together, the circuit board 202 may include one or more spring contacts 214 extending laterally away from the circuit board 202 on both lateral sides of the circuit board 202 and configured to contact the pair of conductors 216 of the cable 102 when the circuit board 202 is inserted into the slot or opening 220 formed through the cable jacket 218. In some embodiments, the one or more spring contacts 214 may include one or more of c-clip spring contacts, box-clip spring contacts, y-clip spring contacts, spring-finger contacts, shield-finger contacts, or pogo-pin contacts. In some embodiments, the spring contacts 214 of the circuit board 202 may vary in type. Furthermore, while four spring contacts 214 are depicted in FIG. 2A through FIG. 3B, the disclosure is not so limited, and the circuit board 202 may include fewer or more spring contacts 214 (e.g., six, eight, ten, or more spring contacts 214).

In some embodiments, the first lateral side 302 of the circuit board 202 may be referred to herein as a ground (GND) lateral side, and the second lateral side 304 of the circuit board 202 may be referred to herein as a data lateral side. Furthermore, on one or more of the first lateral side 302 and second lateral side 304, the spring contacts 214 of that side may be located proximate longitudinal ends of the circuit board 202. For example, when a given lateral side includes two spring contacts 214, a first spring contact 214 may be located proximate a first longitudinal end of the circuit board 202 and a second spring contact 214 may be located proximate a second, opposite longitudinal end of the circuit board 202. In further embodiments, the spring contacts 214 on a given lateral side may be located proximate a center of the circuit board 202 or any other location on the given lateral side of the circuit board 202.

In some embodiments, the spring contacts 214 may include a conductive material (e.g., metallic material, such as copper, gold, silver, etc.), or non-metallic material, such as carbon-fused material (e.g., carbon-fused plastic). In some embodiments, the spring contacts 214 may include a combination of conductive materials (e.g., gold-plated steel, etc.) or a combination of conductive and non-conductive materials (e.g., a combination of gold-plated steel and plastic). As a non-limiting example, one of the spring contacts 214 of a given lateral side of the circuit board 202 may include a conductive material and may be utilized to create an electrical connection with a respective conductor 216 of the cable 102 and to secure the circuit board 202 within the cable 102, and another of the spring contacts 214 of the given lateral side of the circuit board 202 may include non-conductive material and may be utilized to secure the circuit board 202 within the cable 102. A variety of combinations of spring contacts 214 (e.g., conductive and non-conductive, different quantities, different locations, different types, etc.) may be implemented and fall within the scope of the disclosure. In one embodiment, the printed circuit board 202 is conformal coated, such as to reduce the risk of damage due to moisture.

In some embodiments, the circuit board 202 may have a longitudinal length (L) within a range of about 14 millimeters (mm) to about 35.00 millimeters. For example, the circuit board 202 may have a longitudinal length (L) of about 24.0 millimeters (mm). Additionally, the circuit board 202 may have a width (W) within a range of about 3.0 millimeters (mm) to about 10.00 millimeters. For example, the circuit board 202 may have a width (W) of about 5.0 millimeters (mm). It will be understood that other dimensions may be selected based on cable 102 dimensions and are within the scope of the disclosure.

Each of the first seal member 204 and the second seal member 206 may include a plurality of apertures 222 extending therethrough and oriented relative to each other along a longitudinal axis of the respective seal member 204, 206. Furthermore, at least one aperture 222 of each of the first seal member 204 and the second seal member 206 may be sized and shaped to receive a respective filter and/or membrane 208. Additionally, the outer casing 210 may include a pair of apertures 224 extending therethrough and positioned to align with apertures 222 of the first seal member 204 and the second seal member 206 and to expose the filters and/or membranes 208 inserted into the apertures 222 of the first seal member 204 and the second seal member 206.

When assembled, the circuit board 202 may be disposed in between (i.e., interposed between) the pair of conductors 216 of the cable 102 through the slot or opening 220, and a longitudinal axis of the circuit board 202 may be at least substantially parallel to a longitudinal axis of the cable 102. For instance, a center longitudinal axis of the circuit board 202 may be at least substantially collinear with a center longitudinal axis of the cable 102. Furthermore, a first lateral side of the circuit board 202 may face a first conductor 216 of the pair of conductors 216, and a second, opposite lateral side of the circuit board 202 may face a second conductor 216 of the pair of conductors 216. When circuit board 202 is inserted in between the pair of conductors 216 of the cable 102, the spring contacts 214 of the circuit board 202 may press against the pair of conductors 216 of the cable 102. Contact between the spring contacts 214 and the conductor 216 on each lateral side of the circuit board 202 assists in securing the circuit board 202 within the cable 102 and provides electrical connections between the circuit board 202 and the conductors 216 of the cable 102 for power and/or data transfer.

The first seal member 204 and the second seal member 206 may be positioned on opposing sides of the cable 102 (e.g., above and below the circuit board 202 in the view depicted in FIG. 2B) and may be configured to provide seals between the slot or opening 220 (and the circuit board 202) and external environments (e.g., liquids or other materials). In some embodiments, the first seal member 204 and the second seal member 206 are separate and distinct from each other. In additional embodiments, the first seal member 204 and the second seal member 206 may form a single unitary body (e.g., a sleeve). Longitudinal lengths of the first seal member 204 and the second seal member 206 may exceed longitudinal lengths of the slot or opening 220 and the circuit board 202. In some embodiments, together, the first seal member 204 and the second seal member 206 may wrap at least substantially entirely around a periphery of the cable 102. In additional embodiments, the first seal member 204 and the second seal member 206 may cover only portions (e.g., the slot or opening 220 and portions of the cable jacket 218) of the cable 102 and may leave other portions of the cable jacket 218 exposed. In some embodiments, the first seal member 204 and the second seal member 206 may include one or more of an elastomeric material or a polymeric material. For example, the first seal member 204 and/or the second seal member 206 may include one or more of natural rubber (isoprene), styrene-butadiene rubber, butyl, nitrile, neoprene, ethylene propylene diene monomer (EPDM), silicone, Viton®, polyurethane, or hydrogenated nitrile.

In some embodiments, one or more of the first seal member 204 or the second seal member 206 may be bonded to the cable 102. For example, one or more of the first seal member 204 or the second seal member 206 may be bonded to the cable 102 via an adhesive (e.g., glue, epoxy, etc.). In additional embodiments, one or more of the first seal member 204 or the second seal member 206 may be heat-shrunk around the cable 102.

As noted above, each of the first seal member 204 and the second seal member 206 may include an aperture 222 configured to receive a respective filter and/or membrane 208. The filter and/or membrane 208 may include a hydrophobic filter and/or membrane. The hydrophobic filter and/or membrane may enable air and/or vapor (e.g., water vapor) to reach the circuit board 202 and the sensors of the circuit board 202 while preventing liquid water (or other liquids and fluids) from passing through the hydrophobic filter and/or membrane. As a non-limiting example, the filter and/or membrane 208 may include a fluoropolymer tetrafluoroethylene (PTFE) material or any other hydrophobic material. The filter and/or membrane 208 may include filters and/or membranes of various sizes and/or geometries selected based at least partially on a region (e.g., anticipated climate) of the container and/or the stored commodity. In some embodiments, the first seal member 204 and the second seal member 206 may not include apertures 222 and may not include a respective filter and/or membrane 208, e.g., in temperature sensing only applications.

As noted above, in some embodiments, the circuit board 202 may include one or more of humidity sensors, relative humidity sensors, temperature sensors, moisture sensors, and/or carbon dioxide (CO2) sensors.

The outer casing 210 may be sized and shaped to at least substantially entirely cover the first seal member 204 and the second seal member 206. In some embodiments, the outer casing 210 may be sized and shaped to extend at least substantially entirely around a periphery (e.g., circumference) of the cable 102 and encase the first seal member 204 and the second seal member 206. In one or more embodiments, the outer casing 210 may include a single unitary body (e.g., a sleeve). In additional embodiments, the outer casing 210 may include two or more distinct portions. For example, the outer casing 210 may include two clam-shell portions that are sized and shaped to fit together over and around the cable 102 and seal members 204, 206. As noted above, the outer casing 210 may include the pair of apertures 224 extending therethrough and positioned to align with apertures 222 of the first seal member 204 and the second seal member 206 and to expose the filters and/or membranes 208.

In one or more embodiments, the outer casing 210 may include one or more recesses 226 extending around an outer periphery of the outer casing 210 (e. g, extending around the periphery of the outer casing 210 in planes to which a longitudinal axis of the cable 102 is orthogonal (i.e., normal)). The recesses 226 may be sized and shaped to receive the fasteners 212. For example, the fasteners 212 may include clamps (e.g., circle clamps), and the clamps may at least partially fit into the recesses 226 of the outer casing 210. In additional embodiments, the fasteners 212 may include ties or other types of fasteners. The fasteners 212 may be fastened (e.g., tightened) to compress at least portions of the outer casing 210 onto the first seal member 204, the second seal member 206, and the cable 102 to encase the first seal member 204, the second seal member 206, and the cable 102, and as a result, the circuit board 202 within the cable 102.

In some embodiments, the outer casing 210 may serve a seal, and the first seal member 204 and the second seal member 206 may be omitted. In one or more embodiments, the outer casing 210 may include an elastomeric (e.g., a rubber material) or polymeric material. For example, the outer casing 210 may include one or more of natural rubber (isoprene), styrene-butadiene rubber, butyl, nitrile, neoprene, ethylene propylene diene monomer (EPDM), silicone, Viton®, polyurethane, or hydrogenated nitrile.

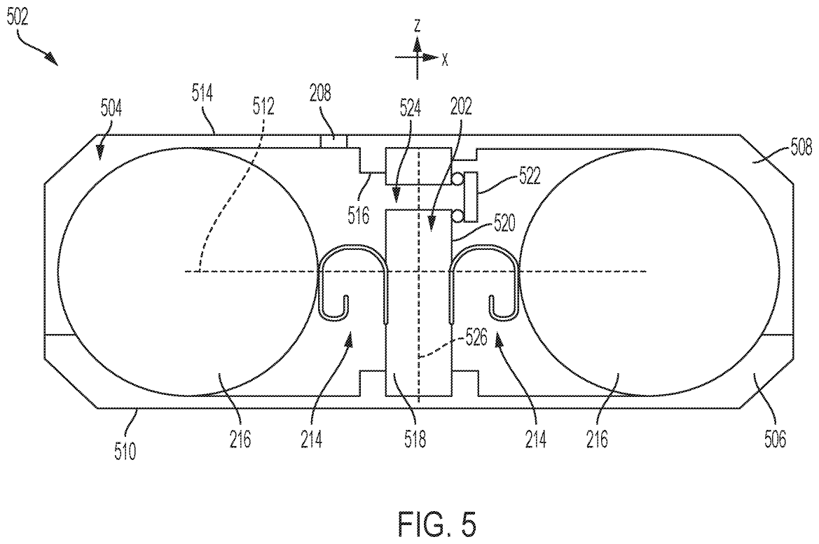

Referring still to FIG. 2A through FIG. 3B together, in some embodiments, the sensor node 124 may further include a housing structure (e.g., a cradle) into which the circuit board 202 may be inserted (e.g., snapped into), and the housing structure may be inserted into the slot or opening 220 within the cable 102. In such embodiments, the spring contacts 214 may extend through apertures in the housing structure and may still contact the conductors 216 of the cable 102. The sensor node 124 and the housing structure (e.g., cradle) are described in further detail in regard to FIG. 5.

Referring to FIG. 1 through FIG. 3B together, in some embodiments, sensor nodes 124 of a given cable 102 may be spaced apart from one another along a length of the cable 102 by a distance within a range of about 0.3 meter and 4.8 meters. For instance, the sensor nodes 124 of a given cable 102 may be spaced apart from one another along a length of the cable 102 by a distance 0.3 meter, 0.6 meter, 1.2 meters, 2.4 meters, or 4.8 meters.

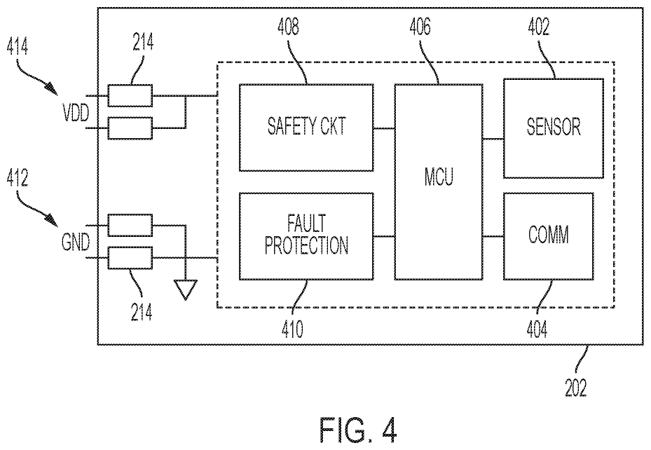

FIG. 4 shows a block diagram of the circuit board 202 according to one or more embodiments of the disclosure. In some embodiments, the circuit board 202 may include sensors 402, a communication interface 404 404, at least one microcontroller unit (MCU 406), fault protection circuitry 410, and safety circuitry 408.

The sensors 402 may include any of the sensors described herein. For example, the sensors 402 may include one or more of temperature sensors, humidity sensors, relative humidity sensors, or carbon-dioxide sensors. In some embodiments, the sensors 402 may include low voltage, low power sensors.

The communication interface 404 may include hardware, software, or both. The communication interface 404 may provide one or more interfaces for communication (such as, for example, packet-based communication) between a computer device (e. g, cable hub 120, at least one client device 110, 112, or gateway 122) and one or more other computing devices or networks (e.g., at least one server 116, 118). As an example, and not by way of limitation, the communication interface 404 may include a network interface controller (NIC) or network adapter for communicating with an Ethernet or other wire-based network or a wireless NIC (WNIC) or wireless adapter for communicating with a wireless network, such as a WI-FI.

The fault protection circuitry 410 may include any conventional fault protection circuitry and may be configured to guard against faults. The safety circuitry 408 may include any conventional safety circuitry and may be configured to provide intrinsic safety for use in hazardous environments. The MCU 406 may include any conventional MCU and may provide for management and control of the circuit board 202. The spring contacts 214 may establish a ground connection 412 and a power/data connection 414 (e.g., a positive voltage supply (VDD)) with the conductors 216 of the cable 102.

FIG. 5 shows a simplified, cross-sectional view of a sensor node 502 according to one or more additional embodiments of the disclosure. The sensor node 502 of FIG. 5 may include any of the elements of the sensor node 124 described above in regard to FIGS. 1-4; however, the sensor node 502 includes a housing structure 504 (e.g., a cradle, a seating structure, etc.) for housing the circuit board 202. In the view depicted in FIG. 5, cable jacket 218 of the cable 102, the first seal member 204, the second seal member 206, and the outer casing 210 are removed for ease of explanation and to better show other elements of the sensor node 502.

In some embodiments, the housing structure 504 may include a first piece 506 and a second piece 508. The first piece 506 and the second piece 508 of the housing structure 504 may be sized and shaped to mate together around the conductors 216 of the cable 102 and to house the circuit board 202 within the housing structure 504. For example, the first piece 506 and the second piece 508 may include mating elements to enable a snap-fit together around the conductors 216 and the circuit board 202. In additional embodiments, the first piece 506 and the second piece 508 may be connected together via an adhesive. Additionally, each of the first piece 506 and the second piece 508 of the housing structure 504 may include a slot structure 516, 518 sized and shaped to receive a lateral edge of the circuit board 202 and to secure the circuit board 202 (e.g., via friction fit) relative to the housing structure 504 and the conductors 216. For example, when the first piece 506 and the second piece 508 are assembled (e.g., snapped) together around the conductors 216 and the circuit board 202, the slot structures 516, 518 may be aligned with one another in the Z-direction depicted in FIG. 5, and the circuit board 202 may be held (e.g., secured) between the slot structures 516, 518.

In the view depicted in FIG. 5, the first piece 506 may define a first outer planar surface 510 below the conductors 216 and at least substantially parallel to a plane 512 extending between center longitudinal axes of the conductors 216 and within which the center longitudinal axes of the conductors 216 lie. For instance, the center longitudinal axes of the conductors 216 may lie within the plane 512. The second piece 508 may define a second outer planar surface 514 above the conductors 216 and at least substantially parallel to the plane 512 and the first outer planar surface 510. It should be noted that the cable jacket 218 also includes outer, substantially-planar surfaces that are at least substantially parallel to the plane 512.

When the circuit board 202 is held within the slot structures 516, 518 of the housing structure 504, lateral surfaces 520 (i.e., major surfaces) of the circuit board 202 defining the first lateral side 302 and the second lateral side 304 of the circuit board 202 may be at least substantially perpendicular to the plane 512 extending between center longitudinal axes of the conductors 216, the first outer planar surface 510 of the housing structure 504, and the second outer planar surface 514 of the housing structure 504. Moreover, the lateral surfaces 520 (i.e., major surfaces) of the circuit board 202 defining the first lateral side 302 and the second lateral side 304 may be perpendicular to the planar surfaces of the cable jacket 218. Furthermore, the lateral surfaces 520 (i.e., major surfaces) of the circuit board 202 defining the first lateral side 302 and the second lateral side 304 may face opposing conductors 216 of the cable 102. In view of the foregoing, a center plane 526 of the circuit board 202 falling within the Z-Y plane, in the view depicted in FIG. 5, may be perpendicular to the plane 512 extending between center longitudinal axes of the conductors 216, the first outer planar surface 510 of the housing structure 504, the second outer planar surface 514 of the housing structure 504, and the planar surfaces of the cable jacket 218.

However, in some additional embodiments, the circuit board 202 may be skewed relative to the Z-axis, and the lateral surfaces 520 (i.e., major surfaces) of the circuit board 202 defining the first lateral side 302 and the second lateral side 304 may not be perpendicular to the plane 512 extending between center longitudinal axes of the conductors 216, the first outer planar surface 510 of the housing structure 504, and the second outer planar surface 514 of the housing structure 504.

Referring still to FIG. 5, the housing structure 504 may include one or more filters and/or membranes 208 permitting air and vapors to pass through the housing structure 504 and reach the circuit board 202. In some embodiments, the one or more filters and/or membranes 208 may include a fluoropolymer tetrafluoroethylene (PTFE) material or any other hydrophobic material.

In the view depicted in FIG. 5, the circuit board 202 includes a relative humidity sensor 522. In such embodiments, the circuit board 202 may include an air passageway 524 extending through the circuit board 202 and from the first lateral side 302 to the second lateral side 304 of the circuit board 202. The air passageway 524 may permit air, and as a result, vapor to reach the humidity sensor 522 from both sides of the circuit board 202. For instance, the humidity sensor 522 may be at least substantially aligned with the air passageway 524.

Referring still to FIG. 5, during installation of the sensor node 502 within the cable 102, the first piece 506 (i.e., the bottom piece depicted in FIG. 5) of the housing structure 504 may be inserted into the slot or opening 220 formed in cable 102 and positioned against the pair of conductors 216. A lateral edge of the circuit board 202 may be disposed within the slot structure 518 of the first piece 506 with the spring contacts 214 of the circuit board 202 pressing against the conductors 216 and at least partially securing the circuit board 202 in place and creating electrical connections (e.g., data, power, and/or ground connections) between the conductors 216 and the circuit board 202. The second piece 508 (i.e., the top piece depicted in FIG. 5) of the housing structure 504 may also be inserted into the slot or opening 220 and positioned over both of the conductors 216 and coupled to the first piece 506. The second piece 508 (i.e., the top piece depicted in FIG. 5) may be placed such that another lateral edge of the circuit board 202 may be disposed within the slot structure 516 of the second piece 508. The housing structure 504, the circuit board 202, and portions of the cable jacket 218 may be covered with the first seal member 204, the second seal member 206, and the outer casing 210 in any of the manners described above in regard to FIG. 1 through FIG. 4.

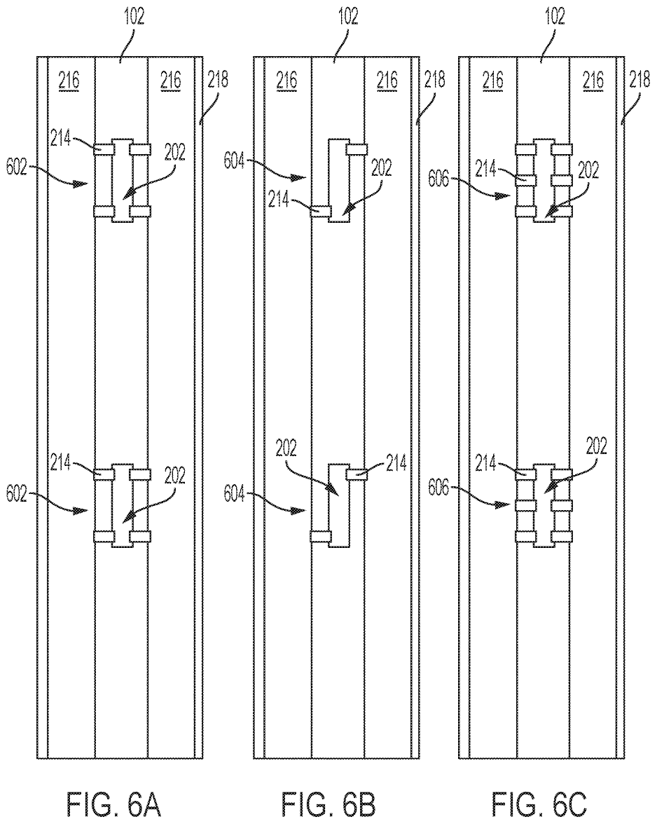

FIG. 6A through FIG. 6B show simplified, schematic views of cables 102 including example sensor nodes 602, 604, 606 distributed along lengths of the cables 102 according to one or more embodiments of the disclosure. The example sensor nodes 602, 604, 606 are for illustrative, non-exhaustive purposes, and wit will be understood by one having ordinary skill in the art in the context of the present disclosure that additional variations may be implemented and are within the scope of the disclosure. The seal members and outer casings are removed from FIG. 6A through FIG. 6C for illustrative purposes.

Referring specifically to FIG. 6A, in some embodiments, the circuit board 202 of the sensor nodes 602 may include two spring contacts 214 on one lateral side of the circuit board 202 and two spring contacts 214 on an opposite lateral side of the circuit board 202. The spring contacts 214 may press against respective conductors 216 of the cable 102. Having a pair of spring contacts 214 on each side of the circuit board 202 may improve operational reliability in regard to the circuit board 202 and may provide redundancy should one of the data or ground sets of spring contacts 214 fail (e.g., corrode). Additionally, having a pair of spring contacts 214 on each side of the circuit board 202 may reduce costs by using a mix of conductive and non-conductive spring contacts 214.

Referring specifically to FIG. 6B, in some embodiments, the circuit board 202 of the sensor nodes 604 may include one spring contact 214 on one lateral side of the circuit board 202 and one spring contact 214 on an opposite lateral side of the circuit board 202. In some embodiments, the spring contacts 214 may be oriented proximate opposing longitudinal ends of the circuit board 202. The spring contacts 214 may press against respective conductors 216 of the cable 102. Offsetting the locations of the spring contacts 214 along a longitudinal length of the circuit board 202 may increase stability of the circuit board 202 relative to the conductors 216, while reducing the quantity of required spring contacts 214, and thereby reducing material costs.

Referring specifically to FIG. 6C, in some embodiments, the circuit board 202 of the sensor nodes 602 may include three spring contacts 214 on one lateral side of the circuit board 202 and three spring contacts 214 on an opposite lateral side of the circuit board 202. The spring contacts 214 may press against respective conductors 216 of the cable 102. Having three spring contacts 214 on each side of the circuit board 202 may improve operational reliability in regard to the circuit board 202 and may provide redundancy should one of the data or ground sets of spring contacts 214 fail (e.g., corrode). Additionally, having three spring contacts 214 on each side of the circuit board 202 may reduce costs by using a mix of conductive and non-conductive spring contacts 214.

Referring to FIG. 6A through 6C together, while each respective cable 102 is shown as have sensor nodes of a same variety (e.g., one spring contact 214 on each side, a pair of spring contacts 214 on each side, three spring contacts 214 of on each side), the disclosure is not so limited, and the sensor nodes of a given cable 102 may vary in variety long a length of the cable 102.

Referring to FIG. 1 through FIG. 6C together, the cable assembly 108 and sensor nodes (referred to hereinafter collectively with the numeral 124) may provide advantages over conventional cable assemblies and sensor nodes. For example, typical sensor nodes include a circuit board soldered to conductors of a cable, and the circuit board is conventionally soldered to one side of both conductors (e.g., above or below the conductors as depicted in FIG. 5). As a result, movement of the cable can result in movement of a circuit board of a sensor node and breaks in one or more solder contacts, which can render the sensor node nonfunctional. In contrast, the sensor nodes 124 of the disclosure are secured between the conductors 216 of the cable 102 and maintain contact with the conductors 216 via spring contacts 214. As a result, movement of the cable 102 does not result in break in connections between the circuit board 202 and the conductors 216. Accordingly, in comparison to conventional sensor nodes, the spring contacts 214 of the sensor nodes 124 of the disclosure provide for a more robust securement of the circuit board 202 to the conductors 216 under conditions of cable 102 movement, which improves the reliability of the sensor nodes 124.

Furthermore, conventional soldering increases costs in fabrication and/or repair and requires specific tools to create the solder contacts and perform inspections to check the integrity of the solder contacts. Alternatively, other affixing mechanisms also introduce added field or manufacturing costs. For instance, conventional crimp mechanisms utilized to affix circuit boards to conductors of the cable require tools for the crimp operation and require intensive inspections to determine the integrity of the crimp. In contrast, the spring contacts 214 of the sensor nodes 124 of the disclosure secure the circuit board 202 to the conductors 216 of the cable 102 without a need for additional tools. The foregoing facilitates relatively easy installation and field replacement of the sensor nodes 124 in comparison to conventional sensors and cables. Additionally, the spring contacts 214 of the sensor node 124 of the disclosure enable relatively easy tests and inspections of the sensor nodes 124 in regard to attachment and/or securement. The foregoing may reduce a required number or frequency of inspections and may increase a quality of the inspections when compared to the inspections required for soldered or crimped connections. Accordingly, the spring contacts 214 of the sensor node 124 of the disclosure improves reliability of the sensor nodes 124 and decreases time and costs involved with installation of the sensor nodes 124 and/or field replacement testing.

Moreover, because the circuit board 202 of the sensor nodes 124 of the disclosure is arranged in between the conductors 216 of the cable 102, as opposed to on top or below the conductors 216, the sensor nodes 124 of the disclosure may exhibit a reduced profile in comparison conventional sensor nodes. For instance, conventional sensor nodes typically exhibit a pronounced profile relative to a profile of a respective cable. The pronounced profile results relatively high shear forces being imposed on the sensor node by the commodity within the container. The reduced profile of the sensor nodes 124 of the disclosure reduces shear forces experienced by the sensor nodes 124 due to the commodity. Accordingly, the load placed on the cables 102 by the commodity is also reduced. Reducing the load on the cables 102 reduces the load on the cable assembly 108 and may provide a more durable cable assembly 108.

All references cited herein are incorporated herein in their entireties. If there is a conflict between definitions herein and in an incorporated reference, the definition herein shall control.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

1. A sensor node, comprising:
a cable comprising a pair of conductors surrounded by a cable jacket; and
a circuit board disposed within the cable and interposed between the pair of conductors of the cable.

2. The sensor node of claim 1, wherein the circuit board comprises a plurality of spring contacts extending away from lateral sides of the circuit board and configured to contact the pair of conductors of the cable.

3. The sensor node of claim 2, wherein at least two spring contacts of the plurality of spring contacts comprise a conductive material.

4. The sensor node of claim 3, wherein one of the at least two spring contacts extends from a first lateral side of the circuit board, and another of the at least two spring contacts extends from a second, opposite lateral side of the circuit board.

5. The sensor node of claim 3, wherein the conductive material comprises a metallic material.

6. The sensor node of claim 3, wherein the conductive material comprises a non-metallic material.

7. The sensor node of claim 2, wherein at least two spring contacts of the plurality of spring contacts comprise a non-conductive material.

8. The sensor node of claim 1, wherein each lateral side surface of the circuit board faces a respective conductor of the pair of conductors, and wherein each lateral side surface of the circuit board is oriented at least substantially perpendicular to a plane extending between center longitudinal axes of the pair of conductors of the cable and within which the center longitudinal axes of the pair of conductors lie.

9. The sensor node of claim 1, wherein the circuit board comprises one or more sensors.

10. The sensor node of claim 9, wherein the one or more sensors comprise at least one of a temperature sensor, a moisture sensor, a humidity sensor, a relative humidity sensor, or a carbon dioxide sensor.

11. The sensor node of claim 1, further comprising at least one seal member disposed on the cable and covering the circuit board.

12. The sensor node of claim 11, wherein the at least one seal member comprises a first seal member disposed on a first side of the cable and a second seal member disposed on a second, opposite side of the cable.

13. The sensor node of claim 11, further comprising at least one filter or membrane disposed within an aperture extending through the at least one seal member and providing a hydrophobic vent.

14. The sensor node of claim 1, wherein the circuit board and a portion of each of the pair of conductors are enclosed in a housing structure.

15. The sensor node of claim 14, wherein the housing structure comprises a first piece and a second piece.

16. A method of forming a sensor node on a cable, comprising:
forming an opening in a cable jacket of the cable; and
disposing a circuit board at least partially within the cable and in-between two conductors of the cable with a first lateral side of the circuit board facing a first conductor of the two conductors and a second lateral side of the circuit board facing a second conductor of the two conductors.

17. The method of claim 16, further comprising disposing a first seal member over the opening in the cable jacket and over the circuit board disposed within the cable.

18. The method of claim 16, wherein forming the opening in the cable jacket of the cable comprises: forming the opening completely through the cable and through both sides of the cable jacket of the cable.

19. The method of claim 16, wherein disposing the circuit board at least partially within the cable and in-between the two conductors of the cable comprises: causing spring contacts of the circuit board to contact at least one of the two conductors of the cable.

20. A commodity monitoring system, comprising:
at least one computing device;
a container for storing a commodity; and
a cable assembly installed within the container and in communication with the at least one computing device, the cable assembly comprising:
a plurality of cables, each cable comprising a pair of conductors; and
a plurality of sensor nodes secured to the plurality of cables, each cable of the plurality of cables having at least one sensor node of the plurality of sensor nodes secured thereto, each sensor node of the plurality of sensor nodes comprising:
a circuit board disposed within a respective cable of the plurality of cables and interposed between the pair of conductors of the respective cable,
wherein each lateral side surface of the circuit board faces a respective conductor of the pair of conductors of the respective cable, and
wherein each lateral side surface of the circuit board is oriented at least substantially perpendicular to a plane extending between center longitudinal axes of the pair of conductors of the respective cable and within which the center longitudinal axes of the pair of conductors lie.
